(19) United States
(12) Patent Application Publication
(10) Pub. No.: US 2018/0157813 A1
(43) Pub. Date: Jun. 7, 2018

(54) Un-locking mechanism for disabled portable computing devices using Quick Response code

(71) Applicant: Jeri Rodrigs, Ottawa (CA)

(72) Inventors: Jeri Rodrigs, Ottawa (CA); Yanwei Wang, Ottawa (CA)

(73) Assignee: Jeri Rodrigs

(21) Appl. No.: 15/368,837

(22) Filed: Dec. 5, 2016

(51) Int. Cl. G06F 21/32; G06K 7/14; G06K 7/10; G06F 21/36; G06K 9/00

(52) U.S. Cl. CPC G06F 21/32; G06K 7/1417; G06K 9/00087; G06F 21/36; G06K 9/00013; G06K 7/10554

(57) ABSTRACT

A Mechanism to unlock disabled portable computing devices using Quick Response (QR) code. The portable computing devices can be in disabled mode due to various reasons like the user can be in driving mode or not in a position to safely operate the device. Un-locking of the device is warranted in some situations, for example the passengers travelling in the same vehicle need to use their portable computing devices. Un-locking portable computing devices mechanism uses the existing utilities already available in the portable computing devices such as camera and finger print scanner. Embodiments of this invention relate to un-locking mechanism using Quick Response code need at least one other portable computing device to unlock a disabled device. One device is used to generate and display the QR code for the other device to scan the QR code and get unlocked. This measure is implemented so that driver engaged in driving cannot unlock the phone by self.

### CROSS-REFERENCE TO RELATED APPLICATIONS

The present application claims the benefit of provisional application 62/291,544 filed on Feb. 5, 2016, the entire content of which is incorporated herein by reference.

### FIELD OF THE INVENTION

This invention relates mainly to facilitate normal operation of portable computing devices, and more precisely, to providing an un-locking mechanism to operate portable computing devices which is in disabled mode that means one or more functions of the portable computing device is disabled when the driver is engaged in driving an automobile. A Quick Response code generator and a scanner in the portable computing devices has put into service to achieve the goal.

### BACKGROUND OF THE INVENTION

Operating phones while driving has become a major fear of road safety in the last decade with 25% of all vehicle accident is the direct result of use of cell phones while driving—That is 1.3 Million crashes every year. So an opportunity exists for portable computing device makers and service providers to put into place a disable mechanism to disable many functions including the input and, possibly, the reception of text messages while the user is driving. Many systems and applications are available in the market now to disable the ability of a portable computing device to perform certain functions, such as texting, emailing while one is driving. The portable computing devices are locked in the disabled mode as a safety measure to protect the driver from distracted driving.

However, there are situations in which restrictions cannot apply to all portable computing devices in a moving vehicle. For example, if it is determined that the portable computing device of a passenger in an automobile being driven by another person is in motion, the passenger's portable computing device cannot be disabled. Since the passenger is not involved in the operation of the vehicle, the passenger's use of the portable computing devices may not pose a safety risk, and there may be no need to disable the passenger's portable computing device or functions on the device. Similarly, it may be inappropriate to disable the portable computing device of passengers on public transportation vehicles such as buses, trains, boats, ships and airplanes.

In these specific situations, the portable computing device is needed to be unlocked. One situation is that all the driver's and passengers' portable computing devices can get disabled and cannot respond to certain functions such as texts. The need arises for the passengers' portable mobile devices to be unlocked for normal operations since they are not involved in the driving. The mechanism is designed to unlock the portable computing device which is disabled to avoid the distracted driving using the Quick Response (QR) code. The type of portable computing devices explained in this invention includes smart phones and tablets, but not limited to them. The portable computing devices can be unlocked from the disabled mode through scanning a unique Quick Response code which is generated on a separate portable computing device.

References Cited
U.S. Patent Documents

| | | |
|---|---|---|
| 8,844,811 | September 2014 | April Elizabeth Rogers |
| 2011/0137742 | June 2011 | Aalap D. Parikh |
| 2012/0280031 | November 2012 | Brad Nelson et al. |
| 2013/0257590 | October 2013 | Adam L. Kuenzi et al. |
| 2013/0317693 | November 2013 | James E. Jefferies et al. |
| 2003/0121968 | July 2003 | Miller et al. |
| 2004/0099026 | May 2004 | Nunez |
| 2010/0045464 | February 2010 | Knopf et al. |
| 2013/0008958 | January 2013 | Smith et al. |
| 2013/0221094 | August 2013 | Smith et al. |
| 2011/0313893 | December 2011 | Weik, III |
| 2012/0280790 | Nov. 8, 2012 | Gerhardt; Paul Michael |

U.S. Pat. No. 8,844,811 discloses an invention of un-locking door locks with QR code provided via email or from a mobile phone application. In this disclosure, the QR code scanner is inside the door lock and un-lock through a processor that can decode the QR code. This doesn't use a second portable computing device to scan the QR code as disclosed in this invention. This invention is not an implementation for un-locking mobiles phones.

US patent application 2011/0137742 discloses only a payment methods and systems are provided to capture a unique product code, such as QR code, on a mobile device, process the information contained in the code, provide the user with options of making a purchase, including purchasing a plurality of selected products from different captured codes, and processing the payment via the user's mobile device.

US patent application 2011/0313893 discloses a control and management system for defined areas such as loading docks, fire stations, and other designated defined areas. A QR code reader provided for a cell phone with picture-taking capability, which communicates with the system to enable a person carrying the cell phone to scan QR codes at specified locations or on specified items or vehicles. This invention is to provide restricted entry to authorized personals with unique QR codes. This invention cannot be implemented for un-locking mobiles phones.

US patent application 2012/0280790 discloses a systems and methods are provided for operating a remotely operable lock. This is a method comprises authenticating, at a web service, credentials received from a portable electronic device, detecting the proximity of the portable electronic device to the lock, and issuing a command for receipt by the lock from the web service or portable electronic device. This invention relies on various elements comprising GPS coordinates, device location, a WiFi ID, a Bluetooth ID, a telephone number, SMS address, pin code, Quick Response (QR) code recognition, and a timed lock operation. This invention is inadequate to be implemented for un-locking mobiles phones.

US patent application 2013/0257590 discloses just another system and method for opening electronic locks employing an image, such as the image of a bar code or a QR code. This cannot explicitly unlock a mobile phone itself.

US patent application 2013/0317693 discloses a rental/car-share vehicle access and management system and method utilizing barcodes and QR codes and can't be used for un-locking portable computing systems.

So given the shortcoming in the prior arts mentioned above, it is apparent that a new novel system to un-lock the disabled portable computing devices is required to enable the use of normal operation of portable computing devices in a moving vehicle by the passengers who are not engaged in driving the automobile.

### SUMMARY OF THE INVENTION

Un-locking mechanism for disabled portable computing devices using Quick Response code is disclosed. Since the un-locking mechanism uses the existing functions already available in the portable computing devices such as camera and finger print scanner, it doesn't require any hardware or other add-on in the device. The disabling of the portable computing devices can happen when the speed in which the device travels exceeds the set threshold and the device is within the range of locating signal. The un-locking mechanism will enable all the disabled functions of the portable computing devices which are disabled in the driving mode to perform as normal devices. With the un-locking mechanism explained here, the devices can be unlocked even if the subject devices are still meeting the requirements of disablement which can be in the range of location detecting signals or above the speed threshold set by disable systems. This location detecting signal can be a built-in blue tooth signal in an automobile or an add-on gigahertz beacon signal.

In one embodiment, a portable computing device can generate and provide a unique and real time QR code with the specific information such as the time line, displayed device information, for the other portable computing devices in the same range of location detecting signals which is one element to trigger the disable mode. Another element to trigger the disable mode is the real-time speed. In this embodiment, the portable computing devices can comprise a motion analyzer, a signal receiver and a camera. The other portable computing devices can scan the QR code using the camera and unlock themselves from the disable mode if the time line is right and falls under the same location detecting signal range.

In another embodiment, the portable computing devices can comprise a motion analyzer, a signal receiver, finger print scanner and a camera. One portable computing device can generate and provide a unique and real time QR code with the specific information such as the time line, displayed device information, after detecting and matching the finger print successfully for the other portable computing devices in the same range of location detecting signals which are disabled as well. In this embodiment, the motion analyzer can detect whether the portable computing device is in motion beyond a predetermined threshold level. The signal receiver can determine whether a holder of portable computing device is located within the range of location detecting signal and un-safe operating area of a vehicle. The finger print scanner will distinguish the person who generates the QR code and who scans the QR code to unlock the portable computing device are under the same location detecting signal range in the vehicle. The other portable computing devices can scan the QR code using the camera after distinguishing successfully using the finger print scanner and unlock themselves from the disable mode.

### BRIEF DESCRIPTION OF THE DRAWINGS

FIG. 1 illustrates exemplary portable computing devices which can generate or scan the unique QR codes for un-locking disabled portable computing devices.

FIG. 2 illustrates a family of devices in a vehicle where one portable computing device in disabled mode (driving mode) which can generate the unique QR code and the other disabled portable computing devices in the same vehicle can scan QR code to unlock from disabled mode.

FIG. 3 illustrates an exemplary process in a portable computing device generating the unique QR code for other portable computing devices to scan.

FIG. 4 illustrates an exemplary process in a portable computing device scanning a QR code to unlock from disabled mode.

FIG. 5 illustrates exemplary elements of the process in generating the unique QR code in a portable computing device.

FIG. 6 illustrates an exemplary process in a portable computing device which is also equipped with a finger print scanner to generate the unique QR code for other portable computing devices to scan.

FIG. 7 illustrates an exemplary process in a portable computing device which is also equipped with a finger print scanner to scan a QR code to unlock from disabled mode.

### DETAILED DESCRIPTION OF THE PREFERRED EMBODIMENTS

In the following description of preferred embodiments, reference is made to the accompanying drawings where it is shown by way of illustration specific embodiments in which the invention can be accomplished. It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Embodiments of the invention relate to un-locking mechanism using Quick Response code for disabled portable computing devices which are prohibited to perform certain functions, such as texting, emailing while one is driving. Although some embodiments of this invention may be described and illustrated herein in terms of an un-locking mechanism, it should be understood that embodiments of this invention are not so limited, but are generally applicable to un-locking any function of a portable computing device that may be in disabled mode because it interfere with the safe operation of a vehicle by a driver. Further, although some embodiments of this invention may be described and illustrated herein in the context of an automobile, it should be understood that embodiments of this invention are not so limited, but are generally applicable to drivers of any vehicle in motion, such as construction vehicle, trucks, trains, boats, ships or airplanes, for example.

During the disabled mode, the portable computing device's radio functions including transmitting and/or receiving capabilities will remain in effect to make sure not to lose any telecommunication messages during the disablement; all the voice and data delivery will be done as per the normal task. Only the device's user interface to enter certain inputs and capability of the device to respond to certain inputs might be disabled, or other restrictions might be placed on one or more of the device's functions where operator's attention and input is required for extended period of time. This facilitates triggering of certain functions upon pressing certain buttons when conditions are met for un-locking the disabled devices.

In all embodiments, the user himself is not given a choice or an opportunity to override the portable computing device's disablement feature since that will undermine the purpose of the invention in preventing distraction of drivers. Embodiments of the invention relate to un-locking mechanism using Quick Response code need at least one other portable devices to unlock a disabled device so that a driver engaged in driving cannot unlock his phone by himself. Since the un-locking mechanism validates for real time QR code for the time line, displayed device information and the same range of location detecting signals, it is not possible for the disabled phone to unlock by scanning any predetermined QR code. This makes the system flawless.

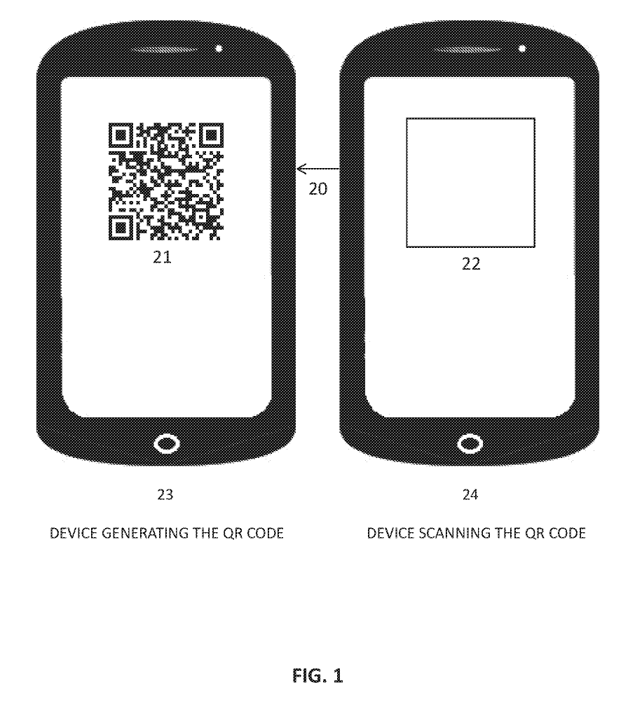

FIG. 1 illustrates two portable computing devices which can implement un-locking mechanism where device 23 generate the unique QR code 21 and device 24 scans 20 the generated QR code 21 for un-locking disabled portable computing devices. In this typical example, device 23 will be the driver held disabled portable computing device and disabled portable computing device 24 will be held by a user riding along in vehicle as a passenger. Special QR generator function is designed to generate QR code in portable computing devices incorporating time line, device information and location signal details. The generated QR code 21 to unlock the disabled devices will be visibly displayed on the device's screen. The scanned QR code 22 will be processed for validity with the information containing time line, device information and location signals information. Device 24 uses the existing camera of the portable computing device to scan 20 the generated QR code 21.

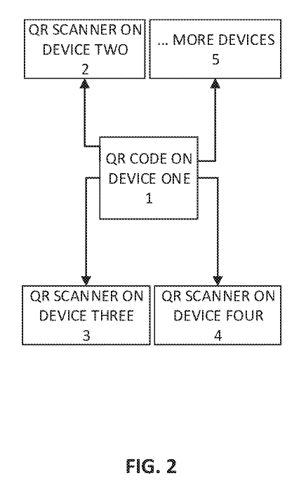

FIG. 2 illustrates cluster of disabled portable computing devices in the same locating signal range which can be in a moving vehicle. The example shows how one portable computing device 1 such as a driver's smart phone generates and displays a unique real time QR code which contains the time line, device information and location signal coordinates. The other portable computing devices 2, 3, 4, 5 which can be passenger's devices can launch the scanner to scan this QR code to unlock from the disabled mode. It also illustrates that it can support any number of devices under the same locating signal range.

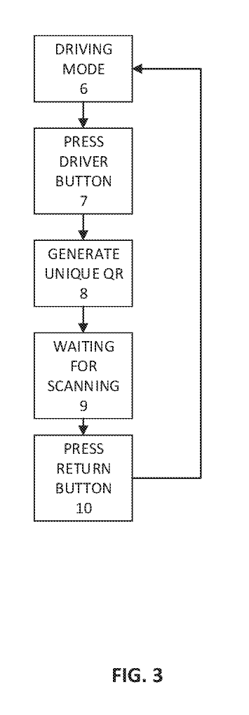

FIG. 3 illustrates an exemplary process in where a portable computing device can generate a unique QR code for other disabled devices to scan. The portable computing device can be in the disabled mode 6 because it is in an automobile which has exceeded the speed limit threshold. When a portable computing device is in a disabled mode, it's touch screen is locked with only two options to enter into, namely 1) driver mode by pressing driver button 7 or 2) passenger mode by pressing passenger button 11. Once the portable computing device 1 is in disabled mode, one can press driver button 7 which will activate the process to generate the unique QR code 8. This action can also be activated by a voice activated command recognition function. The QR code will be displayed on the screen of the portable computing device 1 and waiting for scanning 9. After the other portable computing devices 2, 3, 4, 5 scan the QR code, the device 1 displaying the QR code can return to the disabled driving mode by pressing the return button 10. The waiting for scanning 9 routine has a built in timer so that the device can return to disabled mode 6 even though no one scans the QR code or no one presses the return button 10. The disabled portable computing device 1 which is in driving mode only has options to go back to drive mode 6 only after scanning unless the other conditions of driving no longer exists like speed threshold and locating signal detection.

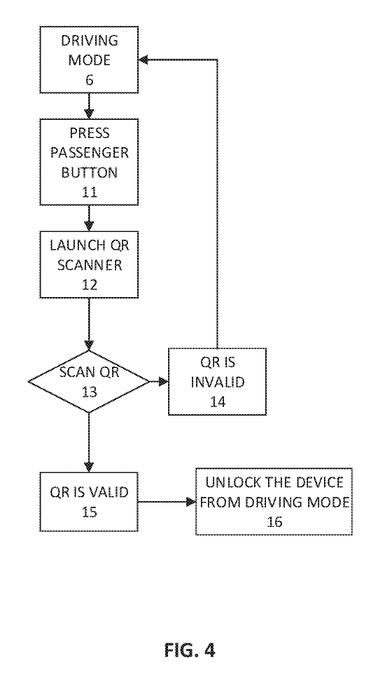

FIG. 4 illustrates an exemplary process in a disabled portable computing device which can scan a QR code to unlock from disabled mode 6. Once the portable computing devices 2, 3, 4, 5 is in disabled mode, one can press or voice command activate the passenger button 11 which will launch the QR scanner 12 for the camera to scan the QR code 21. Once the camera scans the QR code 21, the scan QR code 13 process algorithms will authenticate the QR code for its validity against current time line, device information in which it has been generated and the location signal coordinates. This measure has been put into place to make the feature fool proof and to avoid the disabled portable computing devices scanning a time elapsed QR codes. Once the QR code valid 15 routine distinguishes if the QR code is valid, it will unlock disabled portable computing device 2, 3, 4, 5 from the driving mode 6 to function as normal. If the scan QR code 13 routine detects if the QR code is invalid due to invalid time stamp or wrong locating signal coordinates, then it will trigger QR code is invalid 14 procedure to keep the disabled portable computing device in driving mode 6.

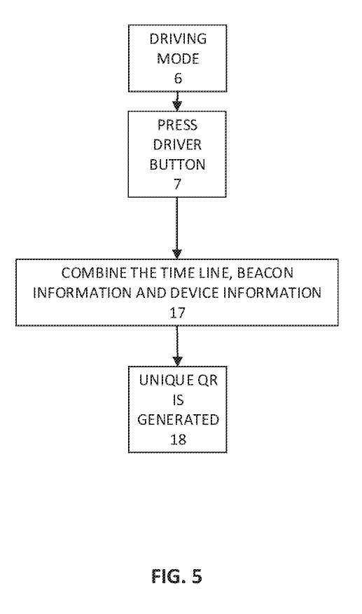

FIG. 5 illustrates an exemplary process of generating the unique QR code in an exemplary portable computing device. The QR code generated in a disabled portable computing device is unique at any given point in time. In driving mode 6, after the driver button is pressed 7 or voice command activated, the QR code is generated based on the time line, locating signal information and the specific information of the portable computing device 17. The QR code is generated 18 and displayed on the screen of the disabled portable computing device for other disabled portable computing devices to scan and unlock.

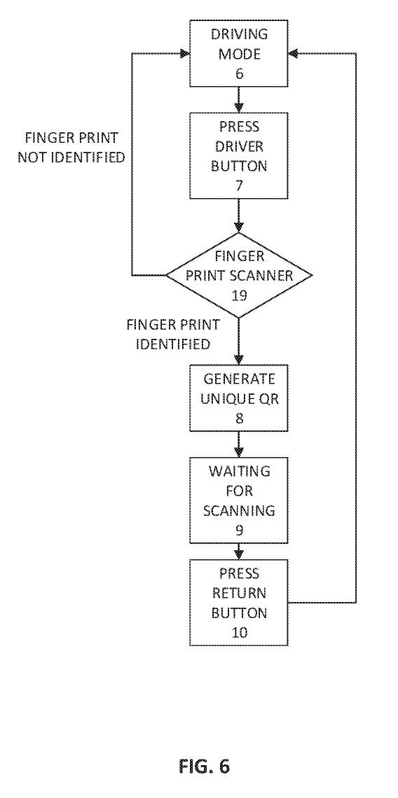

FIG. 6 illustrates an exemplary process in which the portable computing device is also equipped with a finger print scanner generating the unique QR code 21 for other portable computing devices to scan and unlock. The disabled portable computing device 1 which is in driving mode 6 initiates the QR code generation routine when driver button 7 is pressed or voice command activated. First, the QR code generator routine will prompt the user to scan their finger print using the built-in finger print scanner 19 of the portable computing device. The finger print scanner 19 will authenticate the scanned finger print against portable computing device owner's finger print which is already stored in the memory of the device. If the scanned finger print is matching with the stored finger print in the memory of the device, then assumption is made that the owner of the device is authenticating to generate the QR code 8 and the finger print identification procedure is considered to be passed. This will in turn trigger the next step which is generating the QR code 8. The QR code will be displayed on the screen of the portable computing device and waiting for scanning 9. After other portable computing devices 2, 3, 4, 5 scan the QR code, device 1 can return to the disabled driving mode by pressing the return button 10. The waiting for scanning 9 routine has a built in timer so that the device can return to disabled mode 6 even though no one scans the QR code or no one presses the return button 10. The disabled portable computing device 1 which is in driving mode only has options to go back to drive mode 6 only after scanning unless the other conditions of driving no longer exists like speed threshold and locating signal detection.

If the finger print scanner 19 validation of the scanned finger print fails against portable computing device owner's finger print which is stored in the memory of the device, then assumption is made that authorization to generate the QR code 8 is not granted by the owner of the device. In this case the finger print identification procedure is considered to be failed and the device will return to its original state of disabled driving mode 6.

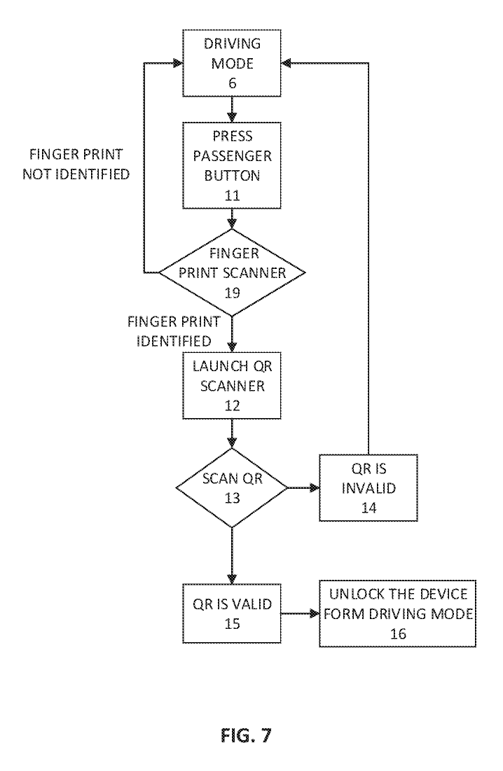

FIG. 7 illustrates an exemplary process in which the portable computing device which is also equipped with a finger print scanner, scanning the unique QR code 21 for disabled portable computing devices to unlock and move to normal operation mode. The disabled portable computing devices 2, 3, 4, 5 which is in driving mode 6 initiates the QR code scanning routine when passenger button 11 is pressed or voice command activated. First, the QR code scanner routine will prompt the user to scan their finger print using the built-in finger print scanner 19 of the portable computing device. The finger print scanner 19 will authenticate the scanned finger print against portable computing device owner's finger print which is already stored in the memory of the device. If the scanned finger print is matching with the stored finger print in the memory of the device, then assumption is made that the owner of the device is authenticating to scan the QR code 21 and the finger print identification procedure is considered to be passed. This will launch QR code scanner 12 which will scan the QR code 13 with the built-in camera in the portable computing device. Once the camera scans the QR code 21, the scan QR code 13 algorithm will authenticate the QR code for its validity against current time line, device information in which it has been generated and the locating signal coordinates. This measure has been out into place to make the feature fool proof and to avoid the disabled portable computing device scanning a time lapsed QR codes. Once the QR code valid 15 routine distinguishes if the QR code is valid, it will unlock disabled portable computing devices 2, 3, 4, 5 from the driving mode 16 to function as normal. If the scan QR code 13 routine detects if the QR code is invalid due to invalid time stamp or wrong locating signal coordinates, then it will trigger QR code is invalid 14 procedure to keep the disabled portable computing device in driving mode 6.

If the finger print scanner 19 validation of the scanned finger print fails against portable computing device owner's finger print which is stored in the memory of the device, then assumption is made that authorization to scan the QR code 13 is not granted by the owner of the device. In this case the finger print identification procedure is considered to be failed and the device will return to its original state of disabled driving mode 6.

What is claimed is:

1. A portable computing device comprising:
A camera configured for photographing images like Quick Response codes;
A display device screen to display the Quick Response code to be scanned by portable computing devices;
A finger print scanning mechanism to scan the finger prints;
A Quick Response code generator to generate QR codes;
A Quick Response code scanner to scan QR codes;
A gigahertz signal receiver configured to determine whether the portable computing device is located within the transmitted signal range location;
A voice command receiver configured to send commands based on the voice commands received to execute one or more functions;
A data transmission method configured to store and send one or more telephonic data to a central data location; and
An un-locking mechanism for disabled portable computing devices using Quick Response code configured to automatically and selectively unlock one or more functions of the portable computing device based on the output of the combined analysis of QR code generator, QR code scanner, finger print scanner and gigahertz signal receiver.

2. The portable computing device of claim 1, wherein the disabled mode of a portable computing device means the inability to type inputs on the screen.

3. The portable computing device of claim 1, wherein the unlocked mode of a portable computing device means the ability to take inputs on the screen and work normally.

4. The portable computing device of claim 1, wherein the device is configured to generate and display the QR code on the device screen.

5. The portable computing device of claim 2, wherein the device is configured to scan the QR code using the built-in camera available in the system.

6. The portable computing device of claim 1, wherein the un-locking mechanism is configured to scan unique QR code and unlock the disabled portable computing device.

7. The portable computing device of claim 1, wherein generation of the QR code can be triggered by a single voice command.

8. The portable computing device of claim 1, wherein scanning of the QR code can be triggered by a single voice command.

9. The portable computing device of claim 1, wherein the un-locking mechanism is configured to switch the device back to disabled mode if the time period expires while waiting for QR code scanning.

10. The portable computing device of claim 1, wherein the un-locking mechanism is configured to scan the finger prints of the user of the device.

11. The portable computing device of claim 1, wherein the un-locking mechanism is configured to trigger the QR code generator if the finger print scanned is matching with the registered user's finger print.

12. The portable computing device of claim 1, wherein the un-locking mechanism is configured not to trigger the QR code generator if the finger print scanned is not matching with the registered user's finger print.

13. The portable computing device of claim 1, wherein the un-locking mechanism is configured to trigger the QR code scanner if the finger print scanned is matching with the registered user's finger print.

14. The portable computing device of claim 1, wherein the un-locking mechanism is configured not to trigger the QR code scanner if the finger print scanned is not matching with the registered user's finger print.

15. The portable computing device of claim 1, wherein the un-locking mechanism is configured to keep the device in disabled mode if the finger print scanned is not matching with the user's finger print.

16. The portable computing device of claim 1, wherein the disabled portable computing device is configured to store and send scanned QR code data to a central data location.

17. The portable computing device of claim 1, wherein the disabled portable computing device is configured to store and send scanned finger print data to a central data location.

18. The portable computing device of claim 1, wherein the un-locking mechanism is configured to scan QR code to unlock the portable computing device for a predetermined period of time.

19. The portable computing device of claim 1, wherein the un-locking mechanism is configured to scan QR code to unlock predetermined number of operations associated with the one or more functions of the portable computing device.

20. A portable computing system comprising:
A camera configured for photographing images like Quick Response codes;
A display device screen to display the Quick Response code to be scanned by portable computing devices;
A finger print scanner device to scan the finger prints;
A Quick Response code generator to generate QR codes;
A Quick Response code scanner to scan QR codes;
A gigahertz signal transmitter configured to transmit location signal to a predetermined range;
A gigahertz signal receiver configured to determine whether the portable computing device is located within the transmitted signal range location;
A voice command receiver configured to send commands based on the voice commands received to execute one or more functions;
A data transmission system configured to store and send one or more telephonic data to a central data location; and
An un-locking mechanism for disabled portable computing devices using Quick Response code configured to automatically and selectively unlock one or more functions of the portable computing device based on the output of the combined analysis of QR code generator, QR code scanner, finger print scanner and gigahertz signal receiver.

21. The portable computing system of claim 20, wherein the gigahertz signal transmitter can be a blue tooth or any other gigahertz beacon signal generator.

22. The portable computing system of claim 20, wherein the portable computing device is configured to detect whether the device is located within the range of locating signal.

23. The portable computing device of claim 20, wherein the un-locking mechanism is configured to authenticate the validity of the scanned QR code with the time line, location signal identity and the device information.

24. The portable computing device of claim 20, wherein the un-locking mechanism is configured to unlock the disabled portable computing device if the validity of the scanned QR code is authenticated with the time line, location signal identity and the device information.

25. The portable computing device of claim 20, wherein the un-locking mechanism is configured to keep the disabled portable computing device in disabled mode if the scanned QR code is invalid due to wrong time line or not generated by a device in the same location signal range.

26. The portable computing system of claim 20, wherein multiple devices can generate the QR code if they are under one location signal range.

27. The portable computing system of claim 20, wherein multiple devices can scan a QR code generated by one device if they both are under one location signal range.
